(19) United States
(12) Patent Application Publication
(10) Pub. No.: US 2007/0193461 A1
(43) Pub. Date: Aug. 23, 2007

(54) METHOD FOR PROVIDING A SUBSTRATE WITH A PRINTED PATTERN WHICH COMPRISES A NUMBER OF SEPARATE PATTERN ELEMENTS

(75) Inventors: Jan-Eric Jack Martijn RUBINGH, Eindhoven (NL); Roy Gerardus Franciscus Antonius VERBEEK, Eindhoven (NL); Ivo Godfried Jozef CAMPS, Eindhoven (NL); Johan Frederik DIJKSMAN, Eindhoven (NL); Adrianus Cornelius VAN KASTEREN, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,569

(22) PCT Filed: Mar. 29, 2005
(86) PCT No.: PCT/IB05/51048

§ 371 Date: Oct. 2, 2006

(30) Foreign Application Priority Data
Apr. 5, 2004 (EP) 04101397.0

(51) Int. Cl. B41F 33/00

(52) U.S. Cl. 101/483

(57) ABSTRACT

During the manufacture of PoIyLED displays, printed elements of the LEDs are obtained by first printing bottom element layers (23a) and subsequently printing top element layers, according to a predetermined pattern. When the dimensions of a PoIyLED display are relatively large, the printing process of each layer (23a) takes place in several strokes. In order to prevent a situation in which unacceptable differences in the height distribution of the obtained elements exist, the layers (23a) of elements which are located at a circumference of a group of elements associated with one printing stroke are printed in two steps. During a first printing stroke, a first portion of the element layers (23a) is printed, whereas during a subsequent printing stroke, the remaining portion of the element layers (23a) is printed. Consequently, the printing strokes are performed in an overlapping manner.

The present invention relates to a method for providing a substrate with a printed pattern which comprises a number of separate pattern elements, wherein each pattern element comprises at least one pattern element part which is obtained by laying down a predetermined number of droplets of printing ink at the position of a substrate portion having a predetermined shape and predetermined dimensions, the method comprising the following successive steps:

printing a first group of pattern element parts during a first printing stroke; and

printing a second group of pattern element parts during a second printing stroke, adjacent to the first group of pattern element parts.

A well-known process in which a printed pattern is obtained on the basis of droplets of printing ink is a so-called ink-jet printing process. In general, such an ink-jet printing process involves laying down a layer of ink on a substrate by means of a print head comprising a number of nozzles for releasing ink droplets. In order to obtain a pattern, the print head and the substrate are moved with respect to each other, while the nozzles are activated to intermittently fire ink droplets towards the substrate. The appearance of the obtained pattern on the substrate is determined by the characteristics of the output of the print head on the one hand, and by the adopted positions of the substrate and the print head with respect to each other on the other hand.

In the following, for the sake of simplicity, it is assumed that during the printing process, the substrate is moved, while the position of the print head is fixed. That does not alter the fact that the present invention is also applicable for the purpose of processes in which a movement of the substrate and the print head is realized in another way, i.e. processes in which only the print head is moved, or in which both the substrate and the print head are moved.

Ink-jet printing proves to be an enabling technology for the manufacturing of displays comprising a large number of light emitting diodes, which displays are commonly referred to as PolyLED displays. In general, PolyLED displays comprise a substrate and a number of light emitting diodes, wherein the light emitting diodes are positioned on the substrate according to a predetermined pattern. Each light emitting diode (commonly referred to as LED) comprises electrodes and a printed element. The printed element comprises a stack of individual layers, wherein each layer may be regarded as a part of the printed element, which is formed by laying down the material of this part dissolved in a solvent on a substrate portion having a predetermined shape and predetermined dimensions. It will be understood that the ink droplets which are released by the print head for the purpose of providing the substrate with the element parts comprise the said solvent and the said material of the parts.

In the following, the present invention will be described in the context of printing PolyLED displays, which does not alter the fact that the present invention is also applicable to other printing processes.

Normally, the printed elements of the LEDs of a PolyLED display comprise two layers. The elements are printed by first printing a bottom layer and subsequently printing a top layer. The present invention pertains to any type of printed element, irrespective of the number of parts of the element, including an element comprising only one part.

In many cases, for the purpose of manufacturing PolyLED displays, the dimensions of the desired pattern are larger than the dimensions of the print head in a direction perpendicular to the direction in which the substrate is moved during the ink-jet printing process. Therefore, in such cases, during the printing process of each element part, the movement of the substrate is performed in two or more strokes, wherein in each stroke, the position of the substrate with respect to the print head is fixed in the direction perpendicular to the direction in which the substrate is moved.

In practice, during the manufacturing process of PolyLED displays, it appears that the printed elements of LEDs which are located at edge portions of the pattern which is printed in one stroke, i.e. LEDs which are located at a periphery of said pattern, are in many cases substantially different from the printed elements of other LEDs, in particular LEDs which are located at a centre of the pattern. The difference pertains to a height distribution of the printed elements, and becomes apparent once the solvent has evaporated, in other words, once the printed element has completely dried up. Consequently, in case the printing process of the parts of the printed elements has been performed in two or more strokes, mutually different bands may be discerned, wherein the height distribution properties of the printed elements of one band differ substantially from the height distribution properties of the printed elements of an adjacent band, as the printed elements of the one band are located at an edge portion of a group of printed elements which is associated with one printing stroke, and the printed elements of the adjacent band are located more at a centre of the group. The height distribution of each printed element has to be within predetermined limits, as the appearance and the operation of the LEDs are related to this property. However, the height distribution differences may be so large that the height distribution of a portion of the printed elements is outside of the limits, as a consequence of which the LEDs associated with said portion of printed elements cannot be used in practice.

For the sake of clarity, it is remarked that the used term “height” should be understood such as to indicate a distance between a top surface of the printed element and a bottom surface of the printed element, wherein it is assumed that the bottom surface of the printed element rests on the substrate. Different portions of the printed element have different heights, so that the top surface of the printed element is not completely planar, but has an uneven appearance. Therefore, the “height distribution” of a printed element pertains to the different heights of the printed element, as determined in directions perpendicular to a direction in which the height is determined. In order for a LED to function properly, the height distribution of its printed element should be between predetermined limits, in other words, the top surface of its printed element should completely fit between an imaginary under limit surface and an imaginary upper limit surface.

It is an important objective of the present invention to adjust the known method for printing PolyLED displays in such a way that the number of printed elements having a height distribution which is unacceptable, in other words, the number of LEDs which can not be used in practice, is reduced, preferably to zero. The objective is achieved by means of a method for providing a substrate with a printed pattern, comprising the following successive steps:

printing a first group of pattern element parts during a first printing stroke; and

printing a second group of pattern element parts during a second printing stroke, adjacent to the first group of pattern element parts;

wherein, during the first printing stroke, only a portion of the predetermined number of ink droplets is laid down at the position of substrate portions which are located at an edge portion of the first group of pattern element parts; and wherein, during the second printing stroke, the remaining portion of the predetermined number of ink droplets is laid down on said substrate portions.

According to an important insight underlying the present invention, the differences in the height distribution of the printed elements are obtained as a result of differences in an evaporation rate of the applied solvent during the printing process. In general, an edge element part printed at an edge portion of a pattern dries quicker than a centre element part printed at a centre portion of the pattern, as a humidity level of the vicinity of the edge element part is lower than the humidity level of the vicinity of the centre element part. By printing element parts at the edge portion in two strokes, wherein a first portion of the element parts is printed during a first stroke, and a remaining portion of the element parts is printed during a subsequent stroke, the evaporation process which takes place at the edge portion is influenced in such a way that its characteristics correspond to those of the evaporation process which takes place at the centre portion, so that a more uniform height distribution of the printed elements of the LEDs is obtained.

According to the present invention, while laying down adjacent groups of element parts, a certain amount of overlap is applied. In particular, when a group of element parts is laid down, an edge portion of this group overlaps an edge portion of a group of element parts which has already been printed. In the following, an area in which the edge portions of the groups of element parts overlap will be referred to as overlap area. In this overlap area, element parts are obtained in two steps. In a first step, a first portion of the ink droplets needed for forming the element part is laid down, whereas in a subsequent step, a remaining portion of the ink droplets needed for forming the element part is laid down. In this way, is it achieved that the way in which the evaporation process of the solvent which is contained by the ink droplets takes place in the overlap area corresponds to the way in which said process takes place in the centre portions of the printed groups of element parts. As a result, the differences in the height distribution of the element parts are diminished to an acceptable level. When all element parts have been printed, the same is true for the differences in the height distribution of the elements.

The present invention also relates to a printing machine which is designed for carrying out the method according to the present invention.

The present invention will now be explained in greater detail with reference to the figures, in which similar parts are indicated by the same reference signs, and in which:

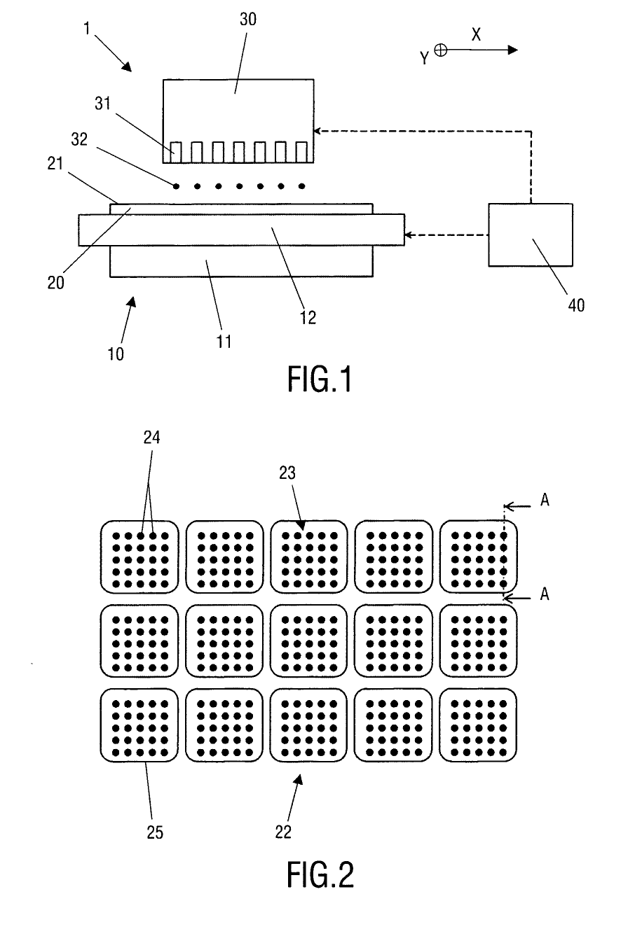

FIG. 1 diagrammatically shows a printing machine;

FIG. 2 diagrammatically shows a printed pattern which comprises a number of LEDs having printed elements;

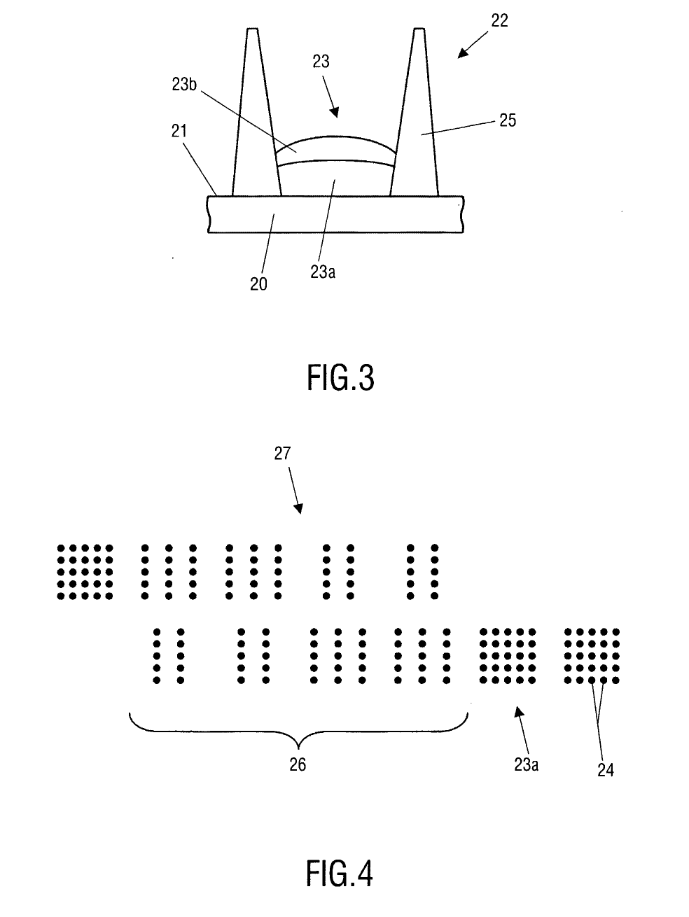

FIG. 3 diagrammatically shows a view of a section taken along line A-A in FIG. 2;

FIG. 4 diagrammatically shows a first possible appearance of edge portions of adjacent groups of printed element parts;

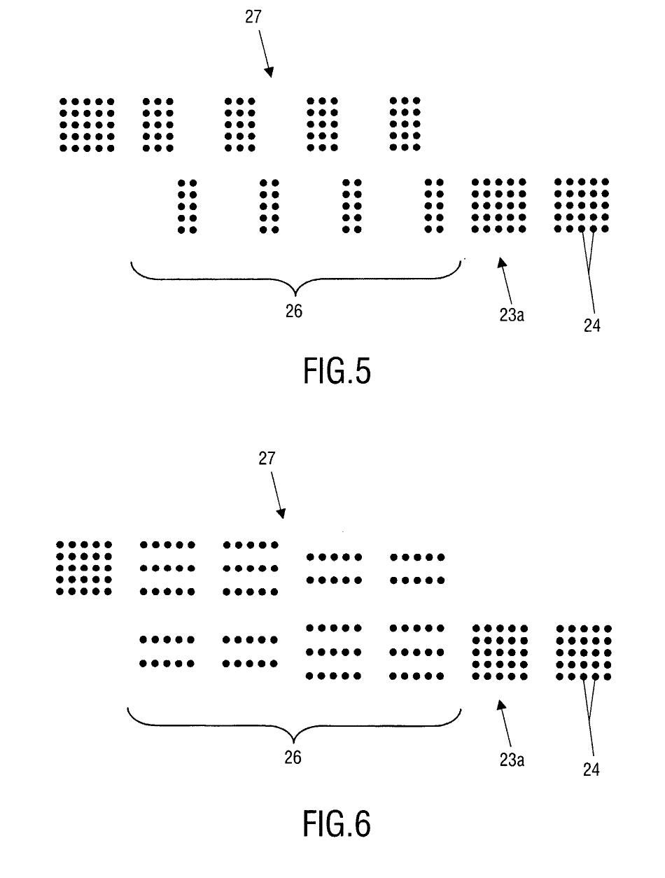

FIG. 5 diagrammatically shows a second possible appearance of edge portions of adjacent groups of printed element parts;

FIG. 6 diagrammatically shows a third possible appearance of edge portions of adjacent groups of printed element parts;

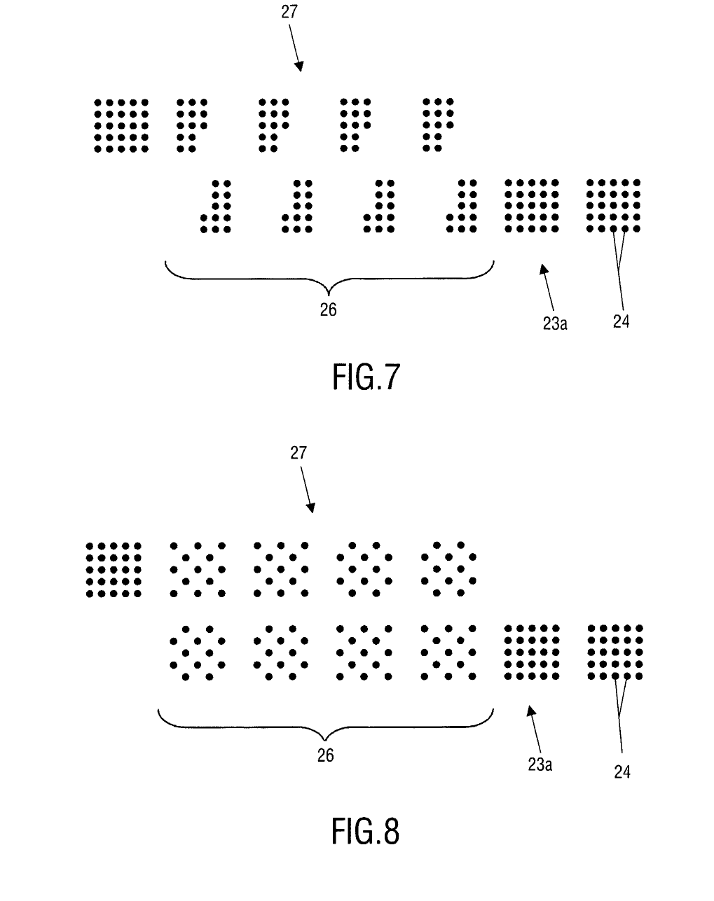

FIG. 7 diagrammatically shows a fourth possible appearance of edge portions of adjacent groups of printed element parts; and

FIG. 8 diagrammatically shows a fifth possible appearance of edge portions of adjacent groups of printed element parts.

In FIG. 1, a printing machine 1 is diagrammatically shown, which comprises a movable table 10 for supporting and moving a substrate 20, and a print head 30 for firing ink droplets towards the substrate 20. The print head 30 is provided with a number of nozzles 31, which may for example be arranged in a row, wherein each nozzle 31 is capable of releasing individual ink droplets. The ink droplets are diagrammatically shown in FIG. 1, and indicated by reference numeral 32. The substrate 20 comprises a receiving surface 21 for receiving the ink droplets 32. In the printing machine 1, the print head 30 is positioned above the receiving surface 21. For the sake of simplicity, a frame of the printing machine 1 for accommodating the various parts of the printing machine 1 is not shown in FIG. 1.

The table 10 comprises an X-table 11 and a Y-table 12. The X-table 11 is movable in an X-direction and the Y-table 12 is movable in a Y-direction, wherein the X-direction and the Y-direction correspond to directions in a plane in which the receiving surface 21 of the substrate 20 extends, and wherein the X-direction and the Y-direction are perpendicular with respect to each other. Both the X-direction and the Y-direction are indicated in FIG. 1.

During operation of the printing machine 1, one of the X-table 11 and the Y-table 12 is moved, in order to place the substrate 20 at predetermined printing positions with respect to the print head 30. Each time the substrate 20 has assumed a printing position with respect to the print head 30, the print head 30 is activated to release ink droplets 32. In this way, a printed pattern is formed on the receiving surface 21 of the substrate 20. For the purpose of controlling the movement of the table 10 and the operation of the print head 30, controlling means 40 are provided.

In general, the ink droplets 32 comprise print material dissolved in a solvent. As soon as an ink droplet 32 has landed on the receiving surface 21 of the substrate 20, a drying process starts, during which the solvent evaporates, while the print material remains on the receiving surface 21. The ink droplet 32 has completely dried up when all solvent has evaporated.

The printing machine 1 may be applied for the purpose of printing LEDs on the substrate 20, which is an important step in a manufacturing process of a PolyLED display. In such a case, the ink droplets 32 are laid down such as to form printed elements, wherein each element covers a substrate portion having a predetermined shape and predetermined dimensions.

Normally, the printed elements of the LEDs comprise two layers, wherein each layer is obtained by laying down ink droplets 32 on the substrate portions, and wherein the ink droplets 32 comprise material of the layer dissolved in a solvent. In printing two successive layers, a subsequent layer may be printed when a preceding layer has dried up, i.e. once all solvent of the preceding layer has evaporated.

An example of a pattern which comprises LEDs having a printed element is shown in FIG. 2. In this figure, the LEDs are indicated by reference numeral 22, the printed elements are indicated by reference numeral 23, and dots which are obtained on the basis of the ink droplets 32 are indicated by reference numeral 24. Each printed element 23 is surrounded by electrodes 25. In the example as shown in FIG. 2, each printed element 23 comprises 5×5 dots 24. It is remarked that in practice, it is not possible to distinguish separate dots 24 of the printed elements 23. Instead, the printed elements 23 comprise continuous layers of print material. FIG. 2 only serves to illustrate the present invention, wherein it is not intended to provide a realistic picture of the actual appearance of the LEDs 22.

FIG. 3 diagrammatically shows a section of a LED 22. In this figure, individual dots 24 are not shown, so that a more realistic view of the printed element 23 of the LED 22 is obtained. In the shown example, the printed element 23 of the LED 22 comprises a bottom layer 23a, which rests on the receiving surface 21 of the substrate 20, and a top layer 23b, which rests on the bottom layer 23a. It will be understood that in the shown example, each element layer 23a, 23b is formed on the basis of 25 ink droplets 32. It is remarked that FIG. 3 illustrates the fact that the printed element 23 comprises a curved top surface and a planar bottom surface, so that different portions of the printed element 23 have different heights, in other words, a height distribution is associated with the printed element 23.

For the purpose of manufacturing PolyLED displays having larger dimensions than the print head 30, the movement of the substrate 20 is performed in two or more strokes, wherein in each stroke, the position of the substrate 20 with respect to the print head 30 is fixed in the direction perpendicular to the direction in which the substrate 20 is moved. It has appeared that due to the fact that the printing process is performed in strokes, mutually different bands may be discerned, wherein the height distribution properties of the printed elements 23 of the LEDs 22 of one band differ substantially from the height distribution properties of the printed elements 23 of the LEDs 22 of an adjacent band. Furthermore, it has appeared that these differences are caused by the phenomenon that the way in which the element layers 23a, 23b dry up is dependent of the position of the element layers 23a, 23b in a group of element layers 23a, 23b which is printed in one stroke. In particular, the rate at which the drying process takes place is higher at an edge portion of the group than at a centre portion of the group.

The present invention provides a solution for the above-sketched problem associated with a printing process according to the state of the art. According to the present invention, adjacent groups of element layers 23a, 23b are printed in an overlapping manner. In the process, an overlap area is created, in which each element layer 23a, 23b is only partially printed during one stroke, and in which each element layer 23a, 23b is completed during a subsequent stroke. In the areas of the receiving surface 21 of the substrate 20 outside of the overlap areas, all ink droplets 32 required to form the element layers 23a, 23b in those areas are laid down in just one stroke.

As a result of printing the element layers 23a, 23b in two steps in the overlap areas, differences between the way in which the drying process of the element layers 23a, 23b takes place in the edge portions of a printed group of element layers 23a, 23b and the way in which said process takes place in the centre portion of the printed group of element layers 23a, 23b are diminished. In this way, it is achieved that the obtained height distribution of a printed element 23 comprising the element layers 23a, 23b is no longer dependent of its position on the substrate 20, and that the height distribution of all elements 23 of a printed pattern is within acceptable limits.

Normally, during each stroke of the printing process, only one of the X-table 11 and the Y-table 12 is moved, while the print head 30 intermittently fires ink droplets 32 towards the receiving surface 21 of the substrate 20. Another one of the X-table 11 and the Y-table 12 is only moved when one stroke of the printing process has finished and another stroke needs to be started. According to the present invention, a distance which is covered while shifting strokes is smaller than a width of one group of element layers 23a, 23b, in other words, smaller than a width of the print head 30.

FIGS. 4-8 illustrate various possibilities of the way in which element layers 23a, 23b in the overlap area are printed. For the sake of the following description, it is assumed that FIGS. 4-8 show the bottom layers 23a. For the sake of simplicity, the electrodes are not shown in FIGS. 4-8.

The way in which the bottom layers 23a are depicted in FIGS. 4-8 is similar to the way in which the printed elements 23 are depicted in FIG. 2. Hence, the bottom layers 23a are depicted as matrices of 5×5 separate dots 24, which is not in conformity with the actual appearance of the bottom layers 23a. However, for the sake of clarity, the bottom layers 23a are depicted in this non-realistic way. It will be understood that in practice, the bottom layers 23a are continuous layers, which are formed on the basis of 25 ink droplets 32, wherein the ink droplets 32 are fired from positions which correspond to the positions of the dots 24 as shown in the figures.

In FIGS. 4-8, the overlap area is indicated by a brace and reference numeral 26. A row of element layers 23a and portions of element layers 23a, which is shown at the top of the figures, represents an edge portion 27 of a row which is printed during a first stroke, whereas a row of element layers 23a and portions of element layers 23a, which is shown at the bottom of the figures, represents an edge portion 27 of a row which is printed during a subsequent stroke. Actually, the rows extend at the same level, but for the sake of clarity, the rows are depicted at different levels in the figures.

In the shown examples, a complete element layer 23a comprises 25 dots 24, which are laid down in 5 rows of 5 dots 24. Furthermore, in the shown examples, 4 element layers 23a are positioned in the overlap area 26. According to an important aspect of the present invention, in the overlap area 26, only a portion of the 25 dots 24 required per element layer 23a is laid down during the first printing stroke, whereas the remaining portion of the 25 dots 24 required per element layer 23a is laid down during the subsequent printing stroke. Outside of the overlap area 26, all 25 dots required per element layer 23a are laid down during one stroke.

In the examples as shown in FIGS. 4 and 5, during the first printing stroke, only a few columns of the element layers 23a in the overlap area 26 are printed, while the remaining columns are printed during the subsequent printing stroke. Preferably, during one stroke, two columns of the element layers 23a are printed, whereas during another stroke, three columns are printed. In this way, it is achieved that 10 dots 24 of the element layers 23a are printed during one stroke, whereas 15 dots 24 are printed during another stroke. The columns which are printed during one stroke may be spaced, as is illustrated by FIG. 4. According to another option, which is illustrated by FIG. 5, the columns which are printed during one stroke are adjacent columns.

In the example as shown in FIG. 6, during the first printing stroke, only a few rows of the element layers 23a in the overlap area 26 are printed, while the remaining rows are printed during the subsequent printing stroke. Preferably, during one stroke, two rows of the element layers 23a are printed, whereas during another stroke, three rows are printed. In this way, it is achieved that 10 dots 24 of the element layers 23a are printed during one stroke, whereas 15 dots 24 are printed during another stroke. The rows which are printed during one stroke may be spaced, as is illustrated by FIG. 6. Nevertheless, it is also possible that the rows which are printed during one stroke are adjacent rows.

In the example as shown in FIG. 7, during the first printing stroke, a first portion comprising 13 dots 24, grouped in 2 adjacent columns and a portion of a column, is printed per element layer 23a, whereas during the subsequent printing stroke, a remaining portion comprising 12 dots 24, also grouped in 2 adjacent columns and a portion of a column, is printed.

In the example as shown in FIG. 8, during both printing strokes, a portion of the dots 24 of the element layers 23a is printed in a spaced manner. In this way, during one printing stroke, 12 dots 24 of the element layers 23a are printed, whereas during another printing stroke, 13 dots 24 are printed.

It will be understood that there are many possible ways for dividing the total of 25 dots 24 per element layer 23a in two portions, and that FIGS. 4-8 show just a few of the possible ways. Irrespective of the way in which the division is made, it is important that during a first printing stroke, only a portion of the ink droplets 32 needed for forming the element layers 23a is released by the print head 30 at the position of the overlap area 26, and that the remaining portion of ink droplets 32 is released during a subsequent stroke. In this way, a vapor pressure prevailing above the element layers 23a in the overlap area 26 is changed with respect to a situation in which all ink droplets 32 needed for forming said element layers 23a are laid down during one stroke. Under the influence of the change of the vapor pressure, the way in which the drying process of the element layers 23a takes place is changed, such that differences between obtained height distributions of the various element layers 23a are diminished. Consequently, when the method according to the present invention is used for printing a pattern of elements 23 on a substrate 20, there are no substantial differences between the height distributions of the obtained elements 23 of the pattern, even if the printing process is performed in a number of strokes. The height distribution of a printed element 23 is independent of the position of this element 23 in a group of elements 23 associated with one printing stroke; it does not matter whether the element 23 is positioned at an edge portion 27 of said group or at a centre portion. According to the present invention, all that is needed to achieve this, is letting edge portions 27 of adjacent groups of element layers 23a, which groups are laid down during subsequent printing strokes, overlap, and printing in two strokes the dots 24 needed for the element layers 23a of the elements 23 which are to be located in an overlap area 26 of the edge portions 27.

It will be clear to a person skilled in the art that the scope of the present invention is not limited to the examples discussed in the foregoing, but that several amendments and modifications thereof are possible without deviating from the scope of the present invention as defined in the attached claims.

In particular, it will be clear that such things as the number of element layers 23a, 23b, the number of ink droplets 32 needed to form an element layer 23a, 23b, and the number of elements 23 located in the overlap area 26 may be chosen freely within the scope of the present invention.

The present invention is relevant in situations in which the height distribution of the various elements 23 of printed patterns needs to be within predetermined limits. This is the case in a context of PolyLED displays comprising LEDs 22 having printed elements 23, as has already been described in the foregoing. However, this is also the case in other contexts, for example a context of liquid crystal displays comprising printed transistors.

Summarizing, during the manufacture of PolyLED displays, printed elements 23 of the LEDs 22 are obtained by first printing bottom element layers 23a and subsequently printing top element layers 23b, according to a predetermined pattern. When the dimensions of a PolyLED display are relatively large, the printing process of each layer 23a, 23b takes place in several strokes. In order to prevent a situation in which unacceptable differences in the height distribution of the obtained elements 23 exist, the layers 23a, 23b of elements 23 which are located at a circumference of a group of elements 23 associated with one printing stroke are printed in two steps. During a first printing stroke, a first portion of the element layers 23a, 23b is printed, whereas during a subsequent printing stroke, the remaining portion of the element layers 23a, 23b is printed. Consequently, the printing strokes are performed in an overlapping manner.

In the foregoing, it has been disclosed that the element layers 23a, 23b which are located in the overlap area 26 are partially printed during a first printing stroke, and are completed during a subsequent printing stroke. The present invention also includes a method in which only a portion of the total number of complete element layers 23a, 23b which are to be printed in the overlap area 26 is printed during a first printing stroke, and in which the remaining portion of the total number of complete element layers 23a, 23b which are to be printed in the overlap area 26 is printed during a subsequent printing stroke.

For example, if 4 rows of 5 element layers 23a, 23b are to be laid down in the overlap area 26, which makes a total of 20 element layers 23a, 23b, 10 element layers 23a, 23b may be printed during a first printing stroke, and 10 element layers 23a, 23b may be printed during a subsequent printing stroke. Preferably, during both printing strokes, the element layers 23a, 23b are printed in a spaced manner. In this way, after the printing process has been performed during the first printing stroke, a pattern of complete pattern layers 23a, 23b is obtained, in which printed pattern layers 23a, 23b alternate with open spaces for receiving pattern layers 23a, 23b. During the second printing stroke, complete element layers 23a, 23b are printed such as to fill the open spaces.

By printing only a portion of the required number of complete pattern layers 23a, 23b in the overlap area 26 during a first printing stroke, and printing another portion of the required number of complete pattern layers 23a, 23b in the same overlap area 26 during a subsequent printing stroke, the rate at which the drying process takes place in the overlap area 26 is influenced. It is possible to influence this rate in such a way that differences between the way in which the drying process of the pattern layers 23a, 23b takes place in the edge portions of a printed group of pattern layers 23a, 23b and the way in which said process takes place in the centre portion of the printed group of pattern layers 23a, 23b are diminished.

1. Method for providing a substrate (20) with a printed pattern which comprises a number of separate pattern elements (23), wherein each pattern element (23) comprises at least one pattern element part (23a, 23b) which is obtained by laying down a predetermined number of droplets (32) of printing ink at the position of a substrate portion having a predetermined shape and predetermined dimensions, the method comprising the following successive steps:
printing a first group of pattern element parts (23a, 23b) during a first printing stroke; and
printing a second group of pattern element parts (23a, 23b) during a second printing stroke, adjacent to the first group of pattern element parts (23a, 23b); wherein, during the first printing stroke, only a portion of the predetermined number of ink droplets (32) is laid down at the position of substrate portions which are located at an edge portion (27) of the first group of pattern element parts (23a, 23b); and wherein, during the second printing stroke, the remaining portion of the predetermined number of ink droplets (32) is laid down on said substrate portions.

2. Method for providing a substrate (20) with a printed pattern which comprises a number of separate pattern elements (23), wherein each pattern element (23) comprises at least one pattern element part (23a, 23b) which is obtained by laying down a predetermined number of droplets (32) of printing ink at the position of a substrate portion having a predetermined shape and predetermined dimensions, the method comprising the following successive steps:
printing a first group of pattern element parts (23a, 23b) during a first printing stroke; and
printing a second group of pattern element parts (23a, 23b) during a second printing stroke, adjacent to the first group of pattern element pars (23a, 23b); wherein only a portion of the pattern element parts (23a, 23b) which are to be printed at an edge portion (27) of the first group of pattern element parts (23a, 23b) is printed during the first printing stroke; and wherein the remaining portion of the pattern element parts (23a, 23b) which are to be printed at an edge portion (27) of the first group of pattern elements (23a, 23b) is printed during the second printing stroke.

3. Method according to claim 1, wherein the pattern element parts (23a, 23b) are printed on a substrate (20) supporting electrodes (25), in order to obtain light emitting diodes (22) comprising electrodes (25) and a printed element (23).

4. Printing machine (1), comprising:
at least one print head (30) for releasing ink droplets (32);
a table (10) for supporting a substrate (20) having a receiving surface (21) for receiving ink droplets (32) from the at least one print head (30);
moving means for moving the at least one print head (30) and the table (10) with respect to each other;
controlling means (40) for controlling the supply of ink droplets (32) by the print head (30) and for controlling the moving means, which are programmed such as to carry out the method according to claim 1.
